(19) United States
(12) Patent Application Publication
(10) Pub. No.: US 2014/0351236 A1
(43) Pub. Date: Nov. 27, 2014

(54) METHOD AND DEVICE FOR WEBSITE SEARCHING ON A WEB BROWSER

(71) Applicant: Tencent Technology (Shenzhen) Co., Ltd., Shenzhen (CN)

(72) Inventor: Zhigang Zhu, Shenzhen (CN)

(21) Appl. No.: 14/336,659

(22) Filed: Jul. 21, 2014

Related U.S. Application Data
(63) Continuation of application No. PCT/CN2014/075981, filed on Apr. 22, 2014.

(30) Foreign Application Priority Data
May 22, 2013 (CN) 2013101923546

(51) Int. Cl. G06F 17/30

(52) U.S. Cl. CPC G06F 17/30864; G06F 17/30876
USPC 707/709

(57) ABSTRACT

A method, apparatus, server and system for websites searching in a browser of a mobile terminal is presented. The method includes the steps of: loading one or more preconfigured website search engine information for generating a website search engine list on a browser search bar; receiving information on which website search engine has been selected from the generated website search engine list; receiving a search keyword input to the browser search bar; sending a search request to the selected website search engine to query the received search keyword; and displaying a search result returned by the selected website search engine upon a successful search.

### CROSS-REFERENCE TO RELATED APPLICATIONS

The application is a continuation of PCT Application No. PCT/CN2014/075981, filed on Apr. 22, 2014, which claims priority to Chinese Patent Application No. 2013101923546, filed on May 22, 2013, which is incorporated by reference in their entireties.

### FIELD OF THE TECHNOLOGY

The present disclosure pertains to the field of mobile terminal, and more particularly, to a method and device for website searching on a web browser.

### BACKGROUND

Current browsers utilize mainly two types of common search bars. A first type of search bar is fixed which is embedded in a toolbar of a browser or a in a position of the browser window. User may search through a preset search engine after inputting keywords in the input box of the search bar. A second type of search bar is embedded in a webpage. To perform a website search in the webpage, the user has to first log on to the webpage through the browser, and afterwards input keywords in the search bar provided on the webpage for refined searching. Neither of the above two website searching methods could launch directly to the target websites, because the target website URL is unknown.

For example, when a user in China shops online through a browser of a mobile phone, the user has to first log into one of the popular shopping websites (such as TaoBao, JingDong, etc.) through the browser of the mobile phone. After launching to the home page of the shopping website, the user needs to input keywords in the search field of the shopping website for searching. Since the browser address bar input box space of the mobile phone is limited by the small size of the mobile phone, it is therefore quite tedious to input a URL (especially a URL with a long address) using either a solid or virtual keypad keyboard on mobile phone. The search efficiency is therefore low.

### SUMMARY

The various embodiments of the present disclosure provide a method and device for website searching on a web browser.

An aspect of the disclosure discloses a method for websites searching in a browser of a mobile terminal. The method includes: includes the steps of: loading one or more preconfigured website search engine information for generating a website search engine list on a browser search bar; receiving information on which website search engine has been selected from the generated website search engine list; receiving a search keyword input to the browser search bar; sending a search request to the selected website search engine to query the received search keyword; and displaying a search result returned by the selected website search engine upon a successful search.

Another aspect of the disclosure discloses a device for website searching in a browser of a mobile terminal, which includes at least a processor operating in conjunction with at least a memory which stores instruction codes operable as plurality of units, wherein the plurality of units include: a list generating unit, which loads one or more preconfigured website search engine information for generating a website search engine list on a browser search bar; a selection information receiving unit, which receives information on which website search engine has been selected from the generated website search engine list; a keywords receiving unit which receives from the selection information receiving unit, a search keyword input to the browser search bar; a searching unit, which sends a search request to the selected website search engine to query the search keyword received by the keyword receiving unit; a display unit, which displays a search result returned by the selected website search engine upon a successful search.

Yet in another embodiment, the disclosure includes a non-transitory computer-readable medium having stored thereon, a computer program having at least one code section being executable by a device or machine for causing the device or machine to perform functions in a mobile terminal, wherein the functions including: loading one or more preconfigured website search engine information for generating a website search engine list on a browser search bar; receiving information on which website search engine has been selected from the generated website search engine list; receiving a search keyword input to the browser search bar; sending a search request to the selected website search engine to query the received search keyword; and displaying a search result returned by the selected website search engine upon a successful search.

The present disclosure takes advantage of the function of supporting sites search in a browser, and enables a user to search directly the desired website in the browser. It is therefore, unnecessary to first log into the website and then search for the target website through the search bar provided by the website. Accordingly, users do not have to memorize or input the exact URL and of these websites any more, thus reducing the operating steps and enhancing the website search engine efficiency.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is an exemplary flow chart illustrating a method for website searching in a browser of a mobile terminal, according to an embodiment of the present disclosure.

FIG. 2 depicts an exemplary input box of a search bar in a browser of the mobile terminal as shown in FIG. 1, according to an embodiment of the present disclosure.

FIG. 3 is an exemplary structural diagram of a device for website searching in a browser of a mobile terminal, according to an embodiment of the present disclosure.

FIG. 4 is an exemplary structural diagram of a mobile terminal, according to an embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features will be referenced back to the prior descriptions.

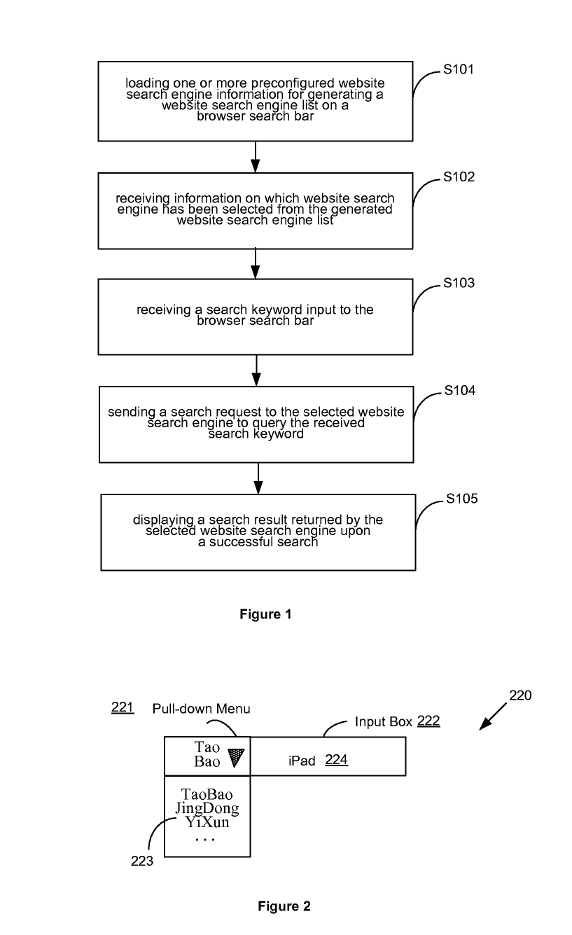

FIG. 1 is an exemplary flow chart illustrating a method for website searching in a browser of a mobile terminal, according to an embodiment of the present disclosure.

In step S101: loading one or more preconfigured website search engine information for generating a website search engine list on a browser search bar

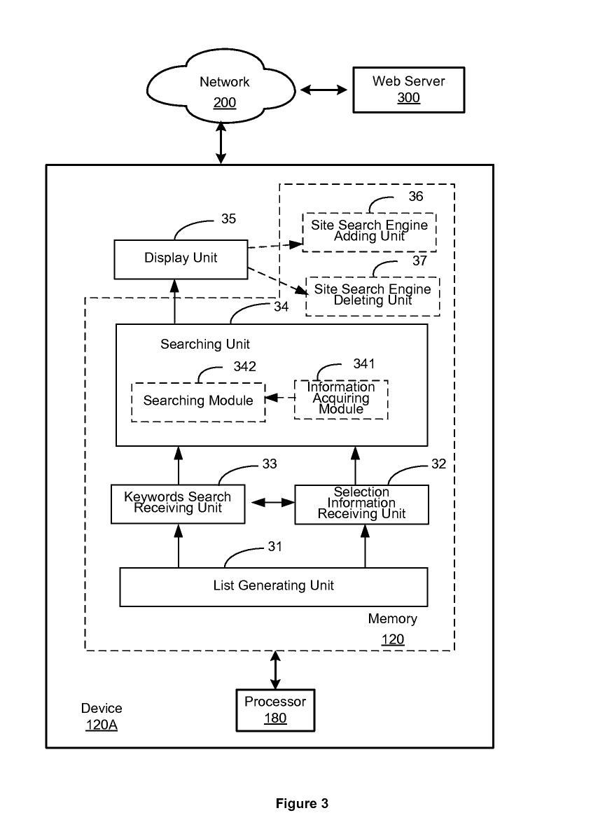

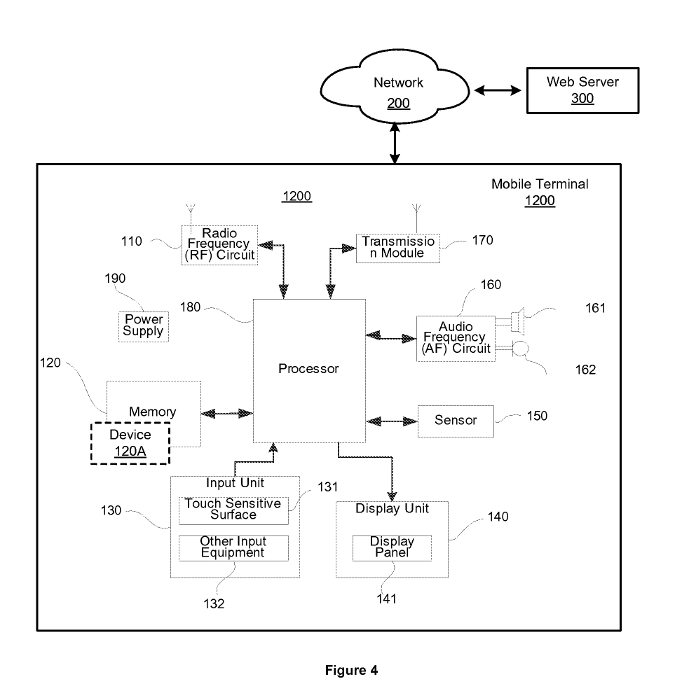

In an embodiment of the disclosure, the site search engine refers to a system which realizes a target website (i.e., the intended destination website) searching function through a search bar in a website. For example, the system which realizes the website searching through the search bar in a shopping website may be hosted by a webs server (see webserver (300) in FIGS. 3 and 4) and may be called the website search engine of the shopping website. In other words, the website search engine of the shopping website may be a function performed by a web server (300) remotely located from the mobile terminal (i.e., mobile terminal (1200) in FIGS. 3 and 4).

The one or more preconfigured website search engine information may include multiple configuration items of website search engines, and the multiple configuration items may include at least the following items belonging to the respective preconfigured website search engine: namely, one or both of a website name and a website icon, and a uniform resource locator (URL) of the website search engine, which may be shown in Table 1:

| Website | Website | |
|---|---|---|
| Name | Icon | URL of Site Search Engine |
| TaoBao | Icon 1 | http://s.m.taobao.com/search.htm?q= |
| JingDong | Icon 2 | http://search.jd.com/search.htm?q= |
| . . . | . . . | . . . |

In the above embodiment, when starting the browser, the browser may automatically load one or more preconfigured website search engine information to generate a website search engine list (as shown in the third column of Table 1) in its search bar. The website search engine list may be displayed by means of (but not limited to) a pull-down menu.

An example of the pull-down menu (221) in the search bar (220) may be depicted as the left column as shown in FIG. 2, while the right portion of the search bar is an input box (222). In other words, a user may input a command to the search bar (220) by clicking or pointing to the pull-down menu (221), a generated site search engine list (223) (as shown in the lower left part of FIG. 2) is displayed for user's selection. The generated website search engine list (223) may include the website name (e.g., Tao Bao, Jing Dong, YiXun, Amazon, ebay, to name a few) and/or website icons of each respective website. FIG. 2 provides a more detail explanation by including the mentioned website names in the generated web site search engine list (223).

It should be noted that the search bar (220) as shown in FIG. 2 is depicted as an example for illustration only. The appearance of the search bar may vary by those skilled in the web browser interface design.

In step S102: receiving information on which website search engine has been selected from the generated website search engine list.

In an embodiment, users may select a desired website search engine (e.g., Tao Bao) from the generated website search engine list (223) displayed by the pull-down menu (221) as shown in FIG. 2.

In step S103: receiving a search keyword input (224) to the browser search bar. It should be noted that step S103 according to the present disclosure is not limited to the order or execution as illustrated FIG. 1. In another embodiment, step S103 may take place prior to step S102. In other words, the input of the search keywords (224) (i.e., the item to be searched or query in the target website, which search keywords may be iPad, Dodge Durango SUV, etc.) may be input or entered to the browser search bar in any order of sequence in FIG. 1, based on the user's own preference, and does not affect the outcome of the disclosed method.

In step S104: sending a search request to the selected website search engine to query the received search keyword (224) send search request to the selected website search engine according to the received keywords (224) for searching. The sending of the search request to the selected website search engine may be based on the acquired URL (i.e., http://s.m.taobao.com/search.htm?q= in Table 1) of the website search engine and the keywords (224) for searching.

In an embodiment of the present disclosure, the sending of a search request to query the selected website search engine may be based on the acquired URL of the website search engine and the keywords (e.g., iPad) for searching, specifically the combination of the acquired URL (i.e., http://s.m.taobao.com/search.htm?q= in Table 1) of website search engine with the keywords for searching, in order to generate a new URL. A search request may be sent based on the new URL, which may directly feedback or return the search result by the selected website search engine according to the search request (i.e., the new URL); or alternately, sending a search request to the selected website search engine based on the acquired URL of the site search engine. The keywords (e.g., iPad) for searching may be carried out in the search request, and the selected website search engine (i.e., http://s.m.taobao.com/search.htm?q= in Table 1) on receive the search request searches according to the carried keywords for searching to acquire the search result.

In the above example, the selected website search engine may be selected from the pull-down menu (221) as TaoBao, the URL of search engine in TaoBao may be acquired as d: http://s.m.taobao.com/search.htm?q=. The user may input a keyword to the selected website search engine to search for an item, such as an iPad. Accordingly, the input search keyword of “ipad” may be combined or append to the URL to generate a new search request: http://s.m.taobao.com/search.htm?q=ipad.

In step S105: displaying a search result returned by the selected website search engine upon a successful search. Specifically, a search result based on the new search request: http://s.m.taobao.com/search.htm?q=ipad may be fed back or returned from the website search engine to be displayed on browser of the mobile terminal (e.g., mobile terminal (1200) in FIGS. 3 and 4).

In an embodiment, the selected website search engine may return the search result according to the search request and displays the search result through a webpage. For example, the search result may be displayed in a new browser page as a bookmark or as a new browser window which the user may acquire the desired information from the search result. More specifically may be a browser page bookmark being the webpage navigation displayed in the browser window.

In another embodiment, the website search engines in the site search engine list may be modified demands of different users. The another embodiment may include the browser may receive a website search engine add command for adding a user's input of new configuration items in order to generate a new website search engine, and displaying the new website search engine added to the generated website search engine list.

When receiving the website search engine add command from a user, a new configuration item of a new site may be loaded into the website search engine to generate a new website search engine, and a new website search engine may be added into and displayed in the website search engine list.

Alternately, the browser may receive a website search engine delete command for deleting one or more selected website search engine in the generated website search engine list. When receiving the website search engine delete command, one or several selected website search engine may be deleted in the website search engine list.

In the embodiment disclosed, the configuration item of each respective website search engine entered or inputted by a user after receiving the website search engine add command may be regarded as a new configuration item of a respective new website search engine.

In practical application, a website search engine add button and site search engine delete button can be preconfigured, or a website search engine add command and the website search engine and may be preconfigured. After receiving an add command from a user, such as the user clicking the website search engine add button or sending to the website search engine an add command, the website search engine may be added. Likewise, after receiving a delete command from a user, such as the user clicking the website search engine delete button or sending to the website search engine a delete command, one or several selected website search engines in the website search engine may be deleted.

In order to better understand the embodiment of the present disclosure, the above process may be explained with the following example. When a user decides to shop on the website of TaoBao through a browser of a mobile phone, the user may first inquire if the TaoBao website search engine may already exist in the pull-down menu (221) of the search bar (220) of browser or not. If yes, the user may select the TaoBao website search engine, and input keywords for searching (e.g., an iPad) in the input box (224) of the browser search bar (220), and then press the “OK” key; the browser of mobile phone (1200) may acquire the URL corresponding to the TaoBao website search engine to link to the site search engine of TaoBao, the website search engine of Taobao will search on a TaoBao server (e.g., webserver 300 in FIGS. 3 and 4) according to the keywords (e.g., iPad) for querying or searching. If an iPad target website of TaoBao is found, the target website may be returned as the corresponding search results. After receiving the search results, the mobile phone will display the search results on a browser page bookmark or as a new browser window for the user to check.

Through the embodiment as described, the user may realize a site search in the target website in a browser directly, and it would be unnecessary to remember and to input the URLs of each of the target websites any more, thus it reduces the operating steps, improves the searching efficiency and greatly provides convenience for users.

FIG. 3 is an exemplary structural diagram of a device (120A) for website searching in a browser of a mobile terminal (1200) (as shown in FIG. 4), according to an embodiment of the present disclosure.

The device (120A) for searching in browser of mobile terminal (1200) may be implemented as a plurality of software units (i.e., as instruction codes) stored in a non-transitory computer readable medium, such as in a memory (120). The device (120A) may also be implemented in a hardware unit, such as in an ASIC or an implemented as a combination of both software and hardware. The device (120A) may be integrated into a mobile terminal (1200) or run in an application system of the mobile terminal (1200) or in a server as an independent application. Alternately, the device (120A) may be implemented as an actual mobile terminal (1200), such as in a smart mobile phone, a tablet PC, a PDA, etc.

More specifically, the device (120A) for website searching in a browser of a mobile terminal (1200) may include at least a processor (180) operating in conjunction with at least a memory (120) which stores instruction codes operable as plurality of units, wherein the plurality of units may include: a list generating unit (31), a selection information receiving unit (32), a keywords search receiving unit (33), a searching unit (34) and a display unit (140). The respective units may perform the following corresponding functions described below:

a list generating unit (31), which loads one or more preconfigured website search engine information for generating a website search engine list on a browser search bar;

a selection information receiving unit (32), which receives information on which website search engine has been selected from the generated website search engine list. The generated website search engine list is generated by the list generating unit 31;

a keywords search receiving unit (33) which receives from the selection information receiving unit, a search keyword input to the browser search bar;

a searching unit (34), which sends a search request to the selected website search engine to query the search keyword received by the keyword receiving unit (33); and

a display unit (35), which displays a search result returned by the selected website search engine upon a successful search.

Wherein, each of the one or more preconfigured website search engine information comprises multiple configuration items, wherein the multiple configuration items comprise at least the following items belonging to the respective preconfigured website search engine: one or both of: a website name and a website icon, and a uniform resource locator (URL).

The searching unit (34) may further include: an information acquiring module (341), which acquires the URL of the selected website search engine from the configuration items of the respective preconfigured website search engine; and a searching module (342), which sends the search request to the selected website search engine based on the acquired URL of the selected website search engine and the received search keyword.

The device (120A) may further include: a site search engine adding unit (36), which: receives a website search engine add command, adds a user's input of new configuration items in order to generate a new website search engine, and displays the new website search engine added to the generated website search engine list.

The device (120A) may further include: a site search engine deleting unit (37), which receives a website search engine delete command for deleting one or more selected website search engine in the generated website search engine list.

Those skilled in the art would recognize that the various units may be implemented in part or in entirety, or integrated into a single hardware processing unit to perform similar functions without limitations.

FIG. 4 is an exemplary structural diagram of a mobile terminal (1200), according to an embodiment of the present disclosure. As shown in FIG. 4, the mobile terminal (1200) may include at least a radio frequency (RF) circuit (110), a memory (120) which may further include at least one or more than one (only one is shown in the figure for illustration) computer readable storage media, an input unit (130), a display unit (140), a sensor (150), an audio frequency (AF) circuit (160), a transmission module (170), a processor (180) which may include one or more than one processing cores, a power supply (190), etc.

The RF circuit (110) receives and transmits electromagnetic waves modulated in RF frequencies, for communication to a network or other equipment. The RF circuit (110) may include various existing circuit elements, such as an antenna, a RF transceiver, a digital signal processor, an encrypting/decrypting chip, a subscriber identity module (SIM) card, a memory (120), etc. The RF circuit (110) may be enabled to communicate with various networks to a web server (300) to carry out the disclosed functions in the described embodiments. The network (200) may be an Internet or a wide area network (WAN), a corporate intranet, a WiFi network, or any suitable wireless network.

The above wireless network can include a cell phone network, a wireless local area network (WLAN) or a metropolitan area network (MAN). The above wireless network (200) may use various communication standards, protocols and technologies, including but not limited to the global system for mobile communication (GSM), enhanced data GSM Environment (EDGE), wideband code division multiple access (W-CDMA), code division access (CDMA), time division multiple access (TDMA), Wireless, Fidelity (WiFi) (such as the standards of the Institute of Electrical and Electronic Engineers (IEEE) including IEEE 802.11a, IEEE 802.11b, IEEE802.11g and/or IEEE 802.11n), voice over internet protocol (VoIP), worldwide interoperability for microwave access (Wi-Max), other protocols configured to e-mail, instant message and text message, and any other applicable communication protocols, even including those protocols which has not been developed up to now.

The Memory (120) may store software programs or instruction codes as the various functional units or modules as described in FIG. 3. The programs may be executed to perform command/module corresponding to the method/device for website searching in a browser of the mobile terminal (1200). The, processor (102) may execute various functional applications and perform data processing by running the software programs and module stored in the memory (120) to realize the functions of website searching in a browser of the mobile terminal (1200).

The Memory (120) may be implemented in the form of high-speed random access memory (RAM), nonvolatile memory, such as read only memory (ROM), magnetic memories, flash memories or other nonvolatile solid state memories. In some examples, the memory (120) may further include remotely located memory such as part of a cloud data base accessed through the network (200).

The Input unit (130) may receive inputted digital or character information generated by a keyboard, a mouse, an operating bar, optical or trackball signal inputs related to user settings with functional control. Specifically, the input unit (130) may include a touch sensitive surface (131) (i.e., touch screen or touch keypad) and from other input equipment (132), which collects user's touch operation on it or nearby (such as user's operation on touch a sensitive surface (131) or near a touch sensitive surface (131) by a finger, touch pen or any other applicable object or accessory).

The Display unit (140) may display information inputted by the user, or display information provided for the user and various graphical user interfaces (GUI) of the mobile terminal (1200) using intuitive figures, texts, icons or dynamic flash animation to assist user's input commands. The Display unit (140) may include a display panel (141) in the form of a liquid crystal display (LCD), organic light-emitting diode (OLED), etc. Furthermore, the touch sensitive surface (131) may overlay the display panel (141) to detect a touch operation on the surface it or in close proximity to the touch sensitive surface (131), which may transmits a detection signal to the processor (180).

The mobile terminal (1200) may also include at least one sensor (150), such as an optical sensor, a motion sensor or other sensors. An optical sensor may include an ambient optical sensor and a proximity sensor, wherein, the ambient optical sensor may regulate luminance of the display panel (141) according to the ambient light, and the proximity sensor may turn off the display panel (141) and/or backlight when the mobile terminal (1200) is moved around towards user's ear. The motion sensor may include a gravitational acceleration sensor which may detect a magnitude of acceleration in all directions (generally in three axes of x, y and z directions) and may detect the magnitude and direction of gravity in static condition. The motion sensor may be configured to recognize movement or gesture applications to the mobile phone (such as screen rotation, related games, posture calibration with a magnetometer), or vibration recognition related functions (such as pedometer, knocking), etc. The mobile terminal (1200) may also be configured with other sensors, including a gyroscope to sense axis orientation, a barometer to sense ambient pressure, a hygrometer to sense humidity, a thermometer to sense ambient temperature and an infrared sensor to sense thermal detection, etc. The above description is for exemplary understanding of their applications only and it is beyond to scope of this disclosure to go into much details.

The audio frequency (AF) circuit (160) may include a speaker (161) and a microphone (162), which may provide an AF interface between the user and the mobile terminal (1200). More specifically, the AF circuit (160) may transmit the received electrical signal after converting the AF data to the speaker (161), and the speaker (161) subsequently converts the AF data into acoustical audio signals as output. Likewise, a microphone (162) may convert the collected acoustical audio signals into electrical signals, and the AF circuit (160) may convert the electrical signals into AF data as outputs to the processor (180) for further signal processing. The processed AF data is then modulated and up-converted by mixing with a carrier in RF frequencies, and transmitted to another mobile terminal through the RF circuit (110). The AF data may also be outputted to the memory (120) for buffering, storage or further processing. The AF circuit (160) may also include an earphone jack to provide communication between a peripheral earphone and the mobile terminal (1200).

The Mobile terminal (1200) may enable the user to perform functions through the network (200), such as to receive and send e-mail messages, browse webpages hosted by the web server (300), access streaming media, etc. The transmission module (170) (such as WiFi module) may provide wireless broadband internet access for the user. Although FIG. 4 discloses only exemplary components, it is nevertheless, beyond the scope of the present disclosure to describe in details the construction of the mobile terminal (1200).

The Processor (180) may function as the control center of the mobile terminal (1200), which almost all functional parts of the mobile phone (1200) are connected to the processor using various interfaces and circuits. The processor (180) may execute various functions of the mobile terminal (1200) and processes data by running or executing the applicable software programs and/or modules which may be stored in the memory (120), and calling data stored in the memory (120). Optionally, the processor (180) may include one or several processing cores. The processor (180) may or may not be integrated with an application processor and a modem processor, wherein, the application processor may mainly process the operating system, user interface, application program, etc., and the modem processor may mainly process wireless radio communication.

The mobile terminal (1200) may include a power supply (190) (such as battery) for supplying power to all electrical components. Preferentially, the power supply (190) may be logically connected to the processor (180) through a power supply management system, such that the power supply may realize functions such as charging and discharging management, power consumption management, etc. through the power supply management system. The Power supply (190) may also include one or both of direct current (DC) or alternate current (AC) power supply, a recharging system, a power supply failure detecting circuit, a power converter or inverter, and a power status indicator, etc.

Although not shown, the mobile terminal (1200) may also include a camera, a Bluetooth module, etc., and there is no need of further description here.

In brief, the mobile terminal (1200) may include a touch screen display, a memory and a plurality of programs stored in the memory (120) to be executed by the processor (180) to perform the functions as recited in the claims section.

In conclusion, the various embodiments of the present disclosure may enable a user to perform a direct search on the target website, by simply entering keywords in the browser of the mobile terminal which is preconfigured with a list of website search engines for ready selection. In effect, the entering of the keywords to the selected website search engine is a single step operation, which removes the requirement of the steps of first launching to access the homepage of the website, use the provided search bar function in the homepage website to search for the relevant website within the webpage, and finally entering a keyword to query the searched website (which takes two to three operations). In addition, the disclosure removes the burden of the user having to memorize or knowing ahead of time the URLs of these websites. The above disclosure thus simplifies the website search operations, improves search efficiency, and enhances user's website search experience.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands are used to enable a computer, server, a smart phone, a tablet or any similar computing device to accomplish the cross-platform video playing operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for websites searching in a browser of a mobile terminal, comprising:
loading one or more preconfigured website search engine information for generating a website search engine list on a browser search bar;
receiving information on which website search engine has been selected from the generated website search engine list;
receiving a search keyword input to the browser search bar;
sending a search request to the selected website search engine to query the received search keyword; and
displaying a search result returned by the selected website search engine upon a successful search.

2. The method according to claim 1, wherein each of the one or more preconfigured website search engine information comprises multiple configuration items, wherein the multiple configuration items comprise at least the following items belonging to the respective preconfigured website search engine:
one or both of: a website name and a website icon, and
a uniform resource locator (URL).

3. The method according to claim 2, wherein the sending of the search request to the selected website search engine for querying the received search keyword, comprising:
acquiring the URL of the selected website search engine from the configuration items of the respective preconfigured website search engine;
sending the search request to the selected website search engine based on the acquired URL of the selected website search engine and the received search keyword.

4. The method according to claim 1, further comprising:
receiving a website search engine add command for adding a user's input of new configuration items in order to generate a new website search engine, and
displaying the new website search engine added to the generated website search engine list.

5. The method according to claim 1, further comprising:
receiving a website search engine delete command for deleting one or more selected website search engine in the generated website search engine list.

6. A device for website searching in a browser of a mobile terminal comprises at least a processor operating in conjunction with at least a memory which stores instruction codes operable as plurality of units, wherein the plurality of units comprise:
a list generating unit, which loads one or more preconfigured website search engine information for generating a website search engine list on a browser search bar;
a selection information receiving unit, which receives information on which website search engine has been selected from the generated website search engine list;
a keywords search receiving unit which receives from the selection information receiving unit, a search keyword input to the browser search bar;
a searching unit, which sends a search request to the selected website search engine to query the search keyword received by the keyword receiving unit;
a display unit, which displays a search result returned by the selected website search engine upon a successful search.

7. The device according to claim 6, wherein each of the one or more preconfigured website search engine information comprises multiple configuration items, wherein the multiple configuration items comprise at least the following items belonging to the respective preconfigured website search engine:
one or both of: a website name and a website icon, and
a uniform resource locator (URL).

8. The device according to claim 7, wherein the searching unit comprises:
an information acquiring module, which acquires the URL of the selected website search engine from the configuration items of the respective preconfigured website search engine;
a searching module, which sends the search request to the selected website search engine based on the acquired URL of the selected website search engine and the received search keyword.

9. The device according to claim 6, further comprises:
a site search engine adding unit, which:
receives a website search engine add command,
adds a user's input of new configuration items in order to generate a new website search engine, and
displays the new website search engine added to the generated website search engine list.

10. The device according to claim 6, further comprises:
a site search engine deleting unit, which receives a website search engine delete command for deleting one or more selected website search engine in the generated website search engine list.

11. A non-transitory computer-readable medium having stored thereon, a computer program having at least one code section being executable by a device or machine for causing the device or machine to perform functions in a mobile terminal, comprising:
loading one or more preconfigured website search engine information for generating a website search engine list on a browser search bar;
receiving information on which website search engine has been selected from the generated website search engine list;
receiving a search keyword input to the browser search bar;
sending a search request to the selected website search engine to query the received search keyword; and
displaying a search result returned by the selected website search engine upon a successful search.

12. The non-transitory computer-readable medium according to claim 11, wherein each of the one or more preconfigured website search engine information comprises multiple configuration items, wherein the multiple configuration items comprise at least the following items belonging to the respective preconfigured website search engine:
one or both of: a website name and a website icon, and
a uniform resource locator (URL).

13. The non-transitory computer-readable medium according to claim 12, wherein the sending of the search request to the selected website search engine for querying the received search keyword, comprising:
acquiring the URL of the selected website search engine from the configuration items of the respective preconfigured website search engine;
sending the search request to the selected website search engine based on the acquired URL of the selected website search engine and the received search keyword.

14. The non-transitory computer-readable medium according to claim 11, further comprising:
receiving a website search engine add command for adding a user's input of new configuration items in order to generate a new website search engine, and
displaying the new website search engine added to the generated website search engine list.

15. The non-transitory computer-readable medium according to claim 11, further comprising:
receiving a website search engine delete command for deleting one or more selected website search engine in the generated website search engine list.
